(19) United States
(12) Patent Application Publication
(10) Pub. No.: US 2015/0141013 A1
(43) Pub. Date: May 21, 2015

(54) HETEROGENEOUS NETWORK LOAD BALANCING

(71) Applicants: AT&T Mobility II LLC, Atlanta, GA (US); AT&T Intellectual Property I, L.P., Atlanta, GA (US)

(72) Inventors: Zhi Cui, Sugar Hill, GA (US); Ye Chen, Milton, GA (US); Hongyan Lei, Plano, TX (US); Cheng P. Liu, Johns Creek, GA (US); Yonghui Tong, Alpharetta, GA (US)

(73) Assignees: AT&T Mobility II LLC, Atlanta, GA (US); AT&T Intellectual Property I, L.P., Atlanta, GA (US)

(21) Appl. No.: 14/084,578

(22) Filed: Nov. 19, 2013

(51) Int. Cl. H04W 36/32

(52) U.S. Cl. CPC H04W 36/32
USPC 455/436

(57) ABSTRACT

A user equipment device cell reselection procedure includes scaling factors that are based on cell-types of a camping cell and neighbor cells and a mobility state of the user equipment device. The scaling factors can be received in a system information block message. During an idle mode cell selection/reselection procedure, the user equipment device can apply the appropriate scaling factor to the hysteresis during the cell selection/reselection procedure.

### TECHNICAL FIELD

The subject disclosure relates to wireless communications and, also generally, to heterogeneous network load balancing.

### BACKGROUND

Use of mobile devices and resulting mobile traffic has been growing at a very fast pace and the trend shows no signs of stopping. To meet the mobile traffic growth and improve the end user experience, mobile service providers are actively looking for mechanisms to improve network efficiency, system capacity, and end user experience. To meet the demand of higher traffic and to improve the end user experience, mobile telecommunications operators are deploying metro cells (also referred to as small cells) in an attempt to help improve coverage and capacity. Mobile telecommunications operators have also been adding more carriers to meet the traffic demand.

### BRIEF DESCRIPTION OF THE DRAWINGS

Various non-limiting embodiments are further described with reference to the accompanying drawings in which:

FIG. 1 illustrates an example, non-limiting wireless communications environment that can be utilized with the disclosed aspects;

FIG. 2 illustrates an example, non-limiting system for network selection/reselection, according to an aspect;

FIG. 3 illustrates an example, non-limiting system for network selection during idle mode, according to an aspect;

FIG. 4 illustrates an example, non-limiting wireless network environment that can be utilized with the disclosed aspects;

FIG. 5 illustrates an example, non-limiting system for idle mode network traffic load balancing in a heterogeneous communications network, according to an aspect;

FIG. 6 illustrates an example, non-limiting method for speed dependent heterogeneous network load balancing in idle mode using cell-type specific scaling factor selection, according to an aspect;

FIG. 7 illustrates an example, non-limiting method for idle mode cell selection/reselection, according to an aspect;

FIG. 8 is a schematic example wireless environment that can operate in accordance with aspects described herein;

FIG. 9 illustrates a block diagram of access equipment and/or software related to access of a network, in accordance with an embodiment; and

FIG. 10 illustrates a block diagram of a computing system, in accordance with an embodiment.

### DETAILED DESCRIPTION

Aspects of the subject disclosure will now be described more fully hereinafter with reference to the accompanying drawings in which example embodiments are shown. In the following description, for purposes of explanation, numerous specific details are set forth in order to provide a thorough understanding of the various embodiments. However, the subject disclosure may be embodied in many different forms and should not be construed as limited to the example embodiments set forth herein.

The disclosed aspects provide enhancements to the idle mode mobility state handling cell reselection procedure. The enhancements include cell-type specific scaling factors, which allow the user equipment device to camp on a best suitable cell. The cell is selected based on the mobility state of the user equipment device and the characteristics of the candidate cells. The user equipment mobility state (e.g., speed, direction, and pattern the device is moving) has an impact on idle mode cell reselection on the types of cells the user equipment device should choose to camp on. Other considerations include the received signal level, the types of cells (e.g., macro, small, or distributed antenna system (DAS)), and the associated radio network congestion situation.

According to an aspect, the user equipment device determines its mobility state (e.g., low, medium, high). The user equipment device also identifies cell-type and/or cell-profile for camping cell and its neighbor cells, which can be through a system information block (SIB) message or through other means. Optionally, the user equipment device receives the cell load conditions of a camping cell and neighboring cells. Then, instead of using cell-type independent scaling factors, the network provides cell-type specific scaling factors to the device via a system information message. Based on the user equipment device detected mobility state, cell-type information, and optionally the cell load conditions (or other network conditions), the user equipment device can apply the proper scaling factors received from the network to make the cell selection/reselection determination.

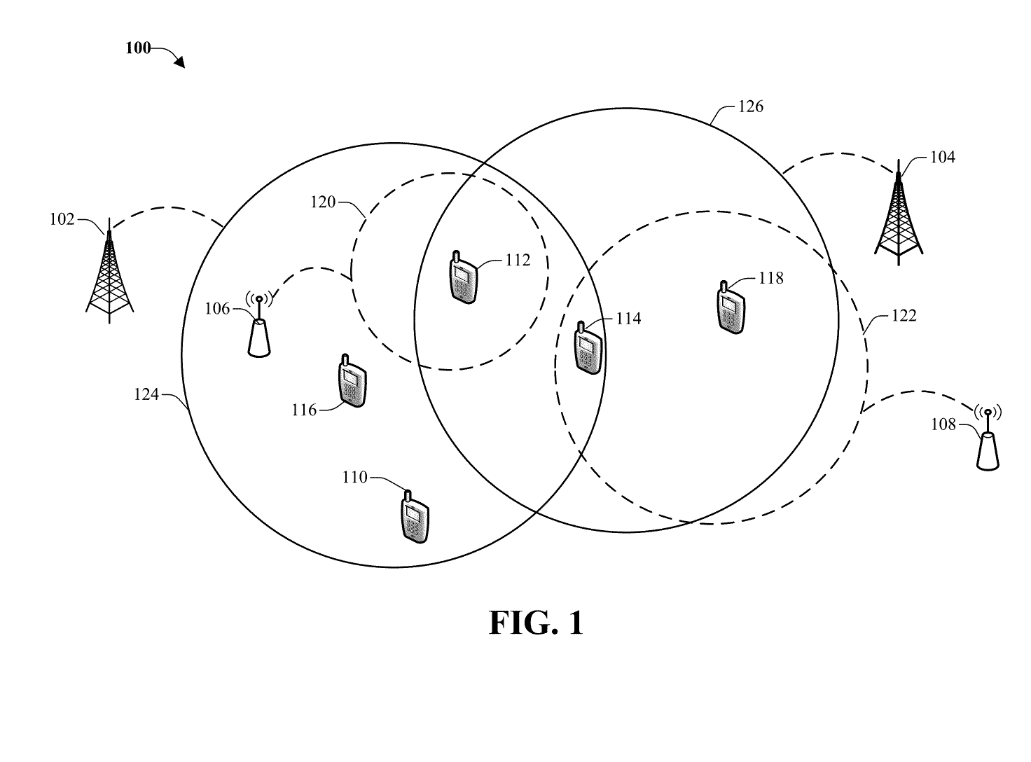

FIG. 1 illustrates an example, non-limiting wireless communications environment 100 that can be utilized with the disclosed aspects. The wireless communications environment 100 can include a multitude of wireless communications networks, each having a respective coverage area. The coverage area of some of the wireless communications networks can overlap such that one or more mobile devices might be served by any of the network devices whose coverage areas overlap. For example, the networks might overlap in accordance with different radio access technologies and may also overlap in radio range such that a first network is capable of receiving signals broadcast by one or more other networks. Further, the wireless communications environment 100 can be a heterogeneous environment that includes heterogeneous networks, which can include multiple different types of cells such as, for example, macro cells, metro cells, femto cells, micro cells, pico cells, and so forth.

A macro cell is a cell in a wireless communications system that provides radio coverage served by a high power cellular access point (or base station) and, therefore has a large coverage area, such as a range of tens of kilometers. A metro cell is a cell in a wireless communications system that provides radio coverage served by a low power cellular access point (or base station) and, therefore has a smaller coverage area than a macro cell. A femto cell is a small, low power cellular access point that can be used in a home or small business, for example. A femto cell is a subset of a type of cell referred to as small cells, which are low-powered radio access nodes that operate in licensed spectrum and unlicensed spectrum and have a range of 10 meters to 1 or 2 kilometers, for example. A micro cell is a cell in a wireless communications system that is served by a low power access point and covers a limited area (e.g., a shopping mall, a hotel, and so on). A micro cell usually has a coverage area that is larger than the coverage area served by a pico cell. The pico cell is a small access point that can cover a small area (e.g., a building) and is used to extend coverage of signals to indoor areas and/or to add network capacity in areas with dense wireless communications usage.

Wireless communications environment 100 includes one or more macro cells 102, 104 and one or more other types of cells, such as one or more small cells 106, 108 deployed within the wireless communications environment 100 and servicing one or more user equipment devices 110, 112, 114, 116, 118. Each wireless communications network (e.g., macro cells 102, 104 and small cells 106, 108) comprises one or more network devices (e.g., a set of network devices) that operate in conjunction in order to process network traffic for the one or more user equipment devices 110, 112, 114, 116, and 118. For example, macro cells 102, 104 can comprise a set of devices that are macro cell enabled devices. In another example, the small cells 106, 108 can include a set of devices that are small cell enabled devices. It is noted that although these networks are described as macro cells 102, 104 and small cells 106, 108, the networks can be other types of cells (e.g., metro cells, femto cells, and so on). Any reference to a particular cell-type is used for purposes of discussion and not limitation according to the various aspects.

As illustrated, each of the one or more small cells 106, 108 has a corresponding service area 120, 122. Further, each of the one or more macro cells 102, 104 has a corresponding service area 124, 126. However, it should be understood that the wireless communications environment 100 is not limited to this implementation. Instead, any number of cells (e.g., macro cells, small cells, femto cells, and so on) and respective service areas can be deployed within the wireless communications environment 100. Further, the geographic areas or cell coverage area can be any shape and can have any dimensions. Thus, the illustrated embodiment should be understood as being illustrative and should not be construed as being limiting in any way.

Further, although only five user equipment devices 110, 112, 114, 116, 118 are illustrated; any number of user devices can be deployed within the wireless communications environment 100. A user equipment device may contain some or all of the functionality of a system, subscriber unit, subscriber station, mobile station, mobile, wireless terminal, device, mobile device, remote station, remote terminal, access terminal, user terminal, terminal, wireless communication device, wireless communication apparatus, user agent, user device, or user equipment (UE). A mobile device can be a cellular telephone, a cordless telephone, a Session Initiation Protocol (SIP) phone, a smart phone, a feature phone, a wireless local loop (WLL) station, a personal digital assistant (PDA), a laptop, a handheld communication device, a handheld computing device, a netbook, a tablet, a satellite radio, a data card, a wireless modem card and/or another processing device for communicating over a wireless system. In addition, the user equipment devices 110, 112, 114, 116, 118 and/or the networks can include functionality as more fully described herein.

In an aspect, the macro cells 102, 104 and the small cells 106, 108 can monitor their surrounding radio conditions (e.g., by employing respective measurement components). For example, each of the macro cells 102, 104 and small cells 106, 108 can determine network traffic load on its respective network by performing a network diagnostic procedure. As an example, during a network listen procedure, macro cells 102, 104 and small cells 106, 108 can scan their radio environment to determine network performance statistics. Various parameters associated with macro cells 102, 104 and small cells 106, 108 can be detected during the network diagnostic procedure, such as, but not limited to, frequency bands, scrambling codes, common channel pilot power, bandwidth across respective networks, universal mobile telecommunications system terrestrial radio access receive signal strength indicator, and so on.

In an example scenario, user equipment devices 110, 112, 114, 116, 118 can be serviced by networks through one of the macro cells 102, 104, or small cells 106, 108. As a user equipment device is moved within the wireless communications environment 100, the respective user equipment device might be moved in and out of the coverage area of the associated serving network. For example, as a user is moving, the user might be walking, riding in a car, riding on a train, moving around a densely populated urban area (e.g., a large city), wherein the movement might cause the mobile device to be moved between various wireless communications networks. In such cases, a cell selection/reselection process can occur.

Cell selection is utilized by a user equipment device in idle mode to quickly search for a cell on which to camp. The user equipment device activates the control channels to receive system information, which is referred to as “camping on the cell.” If the user equipment device finds what is considered a better cell, the user equipment device will reselect that cell and camp on that cell. After camping on that cell, the user equipment device continues to monitor the environment to determine if it should camp on a different cell.

Depending on location, user equipment devices 110, 112, 114, 116, 118 can have the option to select/reselect any number of networks. In one scenario, user equipment device 116 might select/reselect the macro cell 104 or the small cell 106. The small cell might be a good choice for selection/reselection if the user equipment device 116 is being moved slowly (e.g., pedestrian speed, static). However, if the user equipment device 116 is being moved at a fast rate and the user equipment device 116 selects the small cell 106, a short time later, the user equipment device 116 might need to reselect the macro cell 104 or the small cell 108 based on movement of the user equipment device 116. Therefore, based on various aspects disclosed herein the selection/reselection procedure takes into consideration the speed of the user equipment device and the cell-type of the networks that can be selected/reselected.

For example, while in idle mode, the user equipment device 116 can determine the cell-type of the cell on which it is currently camped on (e.g., serving cell) and can also determine the cell-type of the one or more target cells (or neighbor cells). The cell-type of the serving cell and one or more target cells can be classified in two or more categories, such as macro cell and small call. However, the disclosed aspects are not limited to a two-cell-type implementation. Instead, the cells can be classified in three or more categories such as macro cell, femto cell, micro cell, pico cell, and so forth. However, for purposes of simplicity while describing the various aspects, only a two-cell-type classification will be discussed (e.g., macro cell and small cell).

In an aspect, user equipment devices 110, 112, 114, 116, 118 can select/reselect any available network based on real-time or near-real time network condition statistics, mobility state of the respective user equipment device, and cell-type. In an example scenario, user equipment device 116 for example, can determine small cell 106 or macro cell 104 offers a higher quality of experience and user equipment device 116 can perform a cell selection/reselection procedure to make a determination as to which cell to select. The user equipment device 116 can have access to cell-type specific scaling factors, which can be received through a system information message. The cell-type specific scaling factors can be configured such that the device selects/reselects a network more suitable for the speed at which the user equipment device 116 is being moved.

For example, is the user equipment device 116 is determined to be moving at a low speed (e.g., below a threshold level), it might be beneficial to route the traffic of the user equipment device 116 to the small cell 106, provided the small cell 106 can offer an appropriate quality of experience to the device. Thus, the scaling factor can be configured in a matter that when moving at a slow speed, preference for the small cell is factored into the scaling equation. Further to this example, user equipment device 114 might be moving at a higher speed (e.g., above a threshold level) and, based on application of the scaling factors, user equipment device 114 can select/reselect the selected macro cell 104 based, in part on the mobility state of the device. For example, the mobility state information can indicate that the user equipment device is moving at a speed that is not conductive to the metro (e.g., small) cell-type. Therefore, in this case the scaling factor for the device moving at a higher speed can be such that a larger (or macro) cell is preferred.

According to various aspects discussed herein, a user equipment device can continuously, periodically, or based on other temporal conditions, receive data indicative of network statistics (e.g., traffic load or congestion on the network, capability of the network, and so on). As network performance changes, a user equipment device can determine that it should select/reselect a different network. The determination can be made based, in part, on real-time, or real-near time, network statistics.

In accordance with an implementation, the routing of network traffic can be based in part on an access network discovery and selection function policy. The access network discovery and selection function policy can be received from a network server that can be configured to push (e.g., broadcast) the information to the user equipment device. The network selection policy can include logic that can instruct the user equipment device to select or recommend a network based, at least in part, on network statistics, which can include network conditions and load conditions (e.g., network congestion). According to some implementations, one or more network collection agents can monitor multiple networks and can periodically, continuously (e.g., repeatedly) push updated network statistic information to the user equipment device. Such periodic and/or continuous updates can enable real-time or near real-time knowledge of the network conditions by the user equipment device.

User equipment devices can communicate with each other and with other elements via a network, for instance, a wireless network, or a wireline network. A “network” can include broadband wide-area networks such as cellular networks, local-area networks, wireless local-area networks (e.g., Wi-Fi), and personal area networks, such as near-field communication networks including BLUETOOTH®. Communication across a network can be packet-based; however, radio and frequency/amplitude modulation networks can enable communication between communication devices using appropriate analog-digital-analog converters and other elements. Communication is enabled by hardware elements called “transceivers.” User equipment devices can have more than one transceiver, capable of communicating over different networks. For example, a cellular telephone can include a cellular transceiver for communicating with a cellular base station, a Wi-Fi transceiver for communicating with a Wi-Fi network, and a BLUETOOTH® transceiver for communicating with a BLUETOOTH® device. A Wi-Fi network is accessible via “access points” such as wireless routers, etc., that communicate with the Wi-Fi transceiver to send and receive data. The Wi-Fi network can further be connected to the internet or other packet-based networks. The “bandwidth” of a network connection or an access point is a measure of the rate of data transfer, and can be expressed as a quantity of data transferred per unit of time. Additionally, communication (e.g., voice traffic, data traffic, and so on) between one or more components can include wired communications (e.g., routed through a backhaul broadband wired network, an optical fiber backbone, twisted-pair line, T1/E1 phone line, digital subscriber line, coaxial cable, and/or the like), and/or radio broadcasts (e.g., cellular channels, Wi-Fi channels, satellite channels, and/or the like). In accordance with some embodiments, one or more of the user equipment devices can be capable of simultaneous connection to the networks. For example, a user equipment device can be a multi-mode device.

A network can include a plurality of elements that host logic for performing tasks on the network. The logic can be hosted on servers, according to an aspect. In packet-based wide-area networks, servers may be placed at several logical points on the network. Servers may further be in communication with databases and can enable communication devices to access the contents of a database. Billing servers and application servers are examples of such servers. A server can include several network elements, including other servers, and can be logically situated anywhere on a service provider's network, such as the back-end of a cellular network. A server hosts or is in communication with a database hosting an account for a user of a mobile device. The “user account” includes several attributes for a particular user, including a unique identifier of the mobile device(s) owned by the user, relationships with other users, application usage, location, personal settings, business rules, bank accounts, and other information.

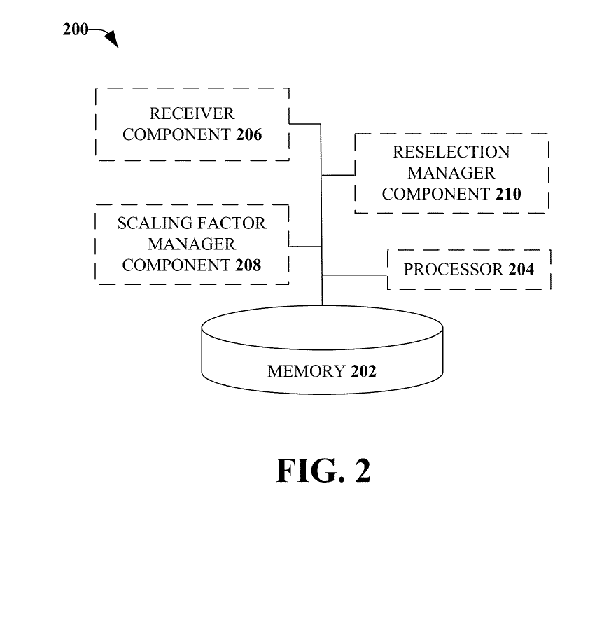

FIG. 2 illustrates an example, non-limiting system 200 for network selection/reselection, according to an aspect. To meet the growing mobile traffic growth demand and improve the end user experience, small cells (referred to as metro cells) are deployed to help improve coverage and capacity of a wireless communications network. Deploying metro cells (also referred to herein interchangeably as small cells) can help to improve coverage and capacity. Therefore, within the mobile carrier's market there can be both macro and small cells in the deployment. In addition, operators are adding more carriers (e.g., in long term evolution (LTE)) to meet the traffic demand. It is noted that although various aspects are described with reference to an LTE network, the aspects can be applied to other networks including a 3G network, for example.

Small cells have lower output power and smaller coverage area as compared to macro cells. The existing user equipment idle mode mobility state handling cell reselection procedure, as specified in 3GPP 36.304, does not distinguish cell-types because that procedure relates to a homogeneous deployment. Thus, the existing standard considers the macro cells and the small cells as being the same. This can result in a user equipment device camping on a small cell, even though the user equipment device is moving fast, which causes a subsequent, unnecessary handover (e.g. to hand out of the small cell into another small cell or into a macro cell). The additional handovers also increase the number of signaling messages that are sent within the network, which further consumes system resources and network bandwidth.

The disclosed aspects can improve cell reselection and user equipment speed-dependent idle mode load balancing in a heterogeneous network environment. In an aspect, the user equipment idle mode mobility state handling cell reselection procedure is enhanced to include cell-type (e.g., macro cell, small cell, DAS, and so on). In another aspect, the cell reselection procedure is enhanced to include cell-profile specific user equipment mobility state scaling factors in a system information block (SIB) message. The additions to the cell reselection procedure allow the user equipment device to apply scaling factors based on its mobility state and cell-type and/or cell profile to make the cell selection/re-selection decision.

As disclosed herein, for a given mobile device, the most suitable cell for its traffic depends on its mobility state (e.g., the speed, direction, and the pattern the device is moving), the received signal level, the types of cells (macro cell, metro cell, DAS, and so on) and the associated radio network congestion situation.

The system 200 comprises at least one memory 202 (e.g., a memory device) that can store computer executable components and instructions. System 200 can also include at least one processor 204 (e.g., a processor device), communicatively coupled to the at least one memory 202. Coupling can include various communications including, but not limited to, direct communications, indirect communications, wired communications, and/or wireless communications. The at least one processor 204 can execute or facilitate execution of the computer executable components stored in the at least one memory 202. The at least one processor 204 can be directly involved in the execution of the computer executable component(s), according to an aspect. Additionally or alternatively, the at least one processor 204 can be indirectly involved in the execution of the computer executable component(s). For example, the at least one processor 204 can direct one or more components to perform the operations.

It is noted that although one or more computer executable components may be described herein and illustrated as components separate from the at least one memory 202 (e.g., operatively connected to memory), in accordance with various embodiments, the one or more computer executable components could be stored in the at least one memory 202. Further, while various components have been illustrated as separate components, it will be appreciated that multiple components can be implemented as a single component, or a single component can be implemented as multiple components, without departing from example embodiments.

System 200 also includes a receiver component 206 configured to receive at least one parameter related to a cell-type of a cell on which the mobile device is currently camped (e.g., serving cell). The receiver component 206 is also configured to receive respective parameters related to cell-types of one or more neighboring cells, which are considered as candidate cells for the mobile device to select/reselect.

In an implementation, the cell-type information can identify a cell (or network) as being of a particular cell-type. The cell-type information can include an explicit specification of a cell-type of one or more networks. For example, a cell information message can include text that explicitly names the cell-type for a given network.

As another example, the cell information message might include a code or identifier by which the cell-type can be ascertained. For example, the system may include a table or other data structure by which to cross-reference cell-type codes or identifiers with cell-types. In an example, non-limiting implementation, the cell-type can be associated with a particular identity or range of identities. For example, an ID (for instance the tracking area ID) range of 100-49,999 may be assigned to macro cells, and a range of 40,000-200,000 may be assigned to metro cells, and so forth.

The cell information message can include any message that is capable of being transmitted over a radio/air interface. Further, the cell information message can be sent using any physical, transport, and/or logical channels. These channel types are known and, therefore, will not be described in further detail herein.

A scaling factor manager component 208 can be configured to apply one or more scaling factors to respective parameters. The selection of which scaling factor to apply is a function of a mobility state of the mobile device and the cell-type.

The mobility state can include information related to whether the user equipment device is stationary or is being moved. The mobility state can also include information as to a speed at which the mobile device is being moved and/or a pattern of movement. For example, the speed can be classified according to various rankings such as, for example, low, medium, and high. In another example, the speed can be classified as fast or slow. In a further example, the speed can be measured and if at or over a certain level (e.g., higher than a predetermined speed) the device is considered to be moving quickly and if under the certain level (e.g., under the predetermined speed), the device is considered to be moving slowly. Further, the direction the device is being moved can be analyzed, according to an aspect.

Scaling factors can be different for each cell-type (e.g., small cell scaling factors are different from macro cell scaling factors). Further, the scaling factors within each set of cell-type (e.g., small cell, macro cell) can be different based on the speed at which the mobile device is being moved.

A reselection manager component 210 can be configured to determine which cell the mobile device should reselect to, or should utilize to access channels during the idle mode. For example, while the mobile device is in idle mode, the mobile device can autonomously perform cell reselection. The cell reselection can be a function of various measurements and can be controlled by cell reselection parameters, which can be broadcast by the network.

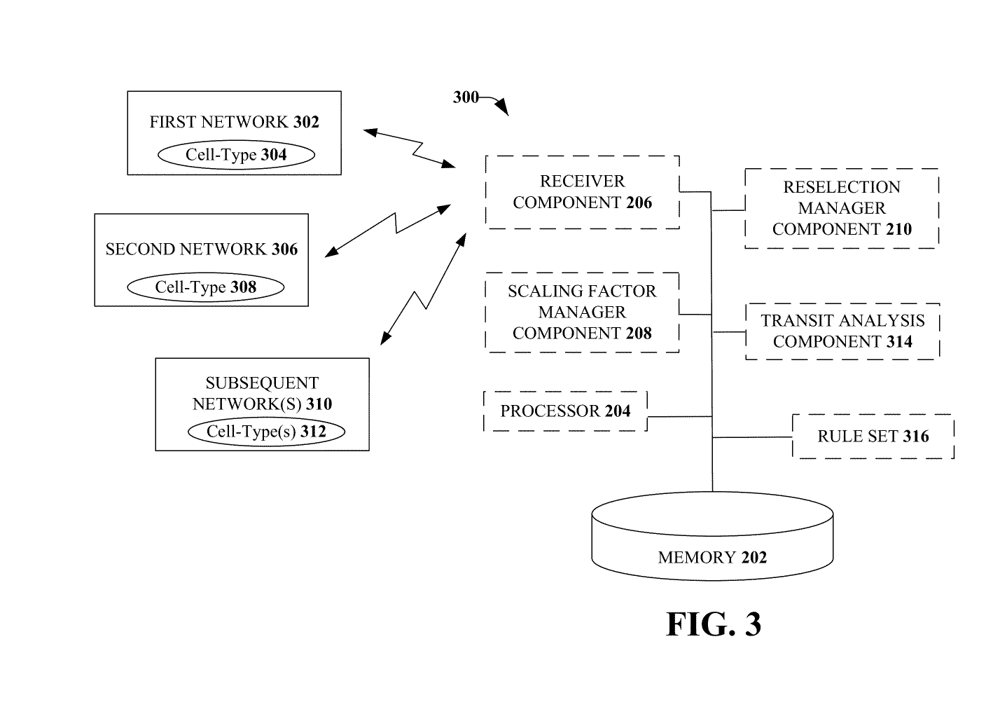

FIG. 3 illustrates an example, non-limiting system 300 for network selection during idle mode, according to an aspect. The system 300 can be implemented by a user equipment device. A receiver component 206 can be configured to receive one or more parameters related to respective cell-types of one or more networks. For example, the receiver component 206 can receive from a first network 302, comprising a first set of devices, a first cell-type 304. The receiver component 206 can also receive from a second network 306, comprising a second set of devices, a second cell-type 308. The first cell-type 304 identifies the cell-type of first network 302 and the second cell-type 308 identifies the cell-type of the second network 306. Further, subsequent networks 310, comprising subsequent sets of device, can broadcast their respective cell-types 312, which can be received at the receiver component 206.

The system can also include a transit analysis component 314 that can be configured to analyze transit data in order to obtain a mobility state of the user equipment device. The transit analysis component 314 is also configured to categorize the speed of the user equipment device.

According to an implementation, the transit analysis component 314 can determine the speed at which the user equipment device is being moved satisfies a first speed level condition, a second speed level condition, a third speed level condition, and so forth. For example, if the user equipment device is being moved less than X miles per hour, the speed level can be categorized as slow. If the user equipment device is being moved more than X miles per hour, but less the Y miles per hour, the speed level can be categorized as medium. Further, if the user equipment device is being moved more than Y miles per hour, the speed level can be categorized as fast. Although three speed levels are described herein, it should be understood that fewer, or more, speed levels can be utilized based on the particular implementation.

For example, the transit analysis component 314 can determine that the user equipment device is being moved rapidly based in part on a frequency component associated with the movement. In an example, a frequency can be associated with train travel. Further to this example, movement of the user equipment device (or a pattern of the movement) indicates a frequency associated with a train crossing track welds, acceleration/deceleration of a train from/into a station, swaying of the train car during transit, and so forth.

In another example, an irregular sinusoidal nature of a frequency can indicate that the user equipment device is being moved, but is not necessarily being moved from one location to another location. For example, the irregular sinusoidal nature can indicate foot tapping, a leg bouncing while the user is seated, and so on. As another example, the gait of the user walking with the user equipment device can be regular and the rise and fall of the body can be periodic. As a further example, the high frequency vibrations of a turbine engine (e.g., a jet engine) can produce recognizable frequency patterns.

Other considerations that can be taken into account by the transit analysis component 314 include the data source information. Such information can include a model, type, brand, date of manufacture, aging or environmental characteristics and so on of the particular user equipment device. Other information can include a data type, such as voltage, current, temporal, numeric, ratio, instant historical, and so on. Also considered can be a data acquisition window, data acquisition environment, historic data, user preferences, user defined data, data reference frame(s), multiple data sources, and so on.

The transit analysis component 314 can utilize various motion sensors including, but not limited to, global positioning system (GPS) data, accelerometers, speed calculations between access points for given time intervals, and so on. Further, the transit analysis component 314 can analyze information associated with the various motion sensors to determine close matches (or perfect matches) between known (or inferred) patterns and accessible user equipment device transit patterns.

Based on the cell-type (e.g., macro cell, small cell, and so on) and the mobility state of the user equipment device, the scaling factor manager component 208 can be configured to obtain a scaling factor that is to be used during a cell reselection procedure. For example, the scaling factor manager component 208 can be configured to access a rule set 316. The rule set 316 can be obtained from the network (e.g., a service network), for example.

The following provides an example, non-limiting cell-type specific scaling factors that can be provided to the system 300 via a system information message. The cell-type specific factors can separate the cells into two types of cells, namely, macro cells and small cells. However, more than two different cell types can be utilized in various implementations. Each cell-type can further be mapped to different scaling factors as a function of the user equipment device movement. For example, a macro cell can be associated with (or mapped to) three (or more) different scaling factors, such as a first scaling factor for high speed, a second scaling factor for medium speed, and a third scaling factor for slow/no movement (also referred to herein as “normal” or “pedestrian” speed). In a similar manner, a small cell can be associated with (e.g., mapped to) three (or more) different scaling factors, namely, a first scaling factor for high speed, a second scaling factor for medium speed, and a third scaling factor for slow/no movement. For example, for high speed, the scaling factors can be as follows:
“sf-High-small for Qhyst” to Qhyst
“sf-High-macro for Qhyst” to Qhyst
   where “sf” is scaling factor; “High” indicates high speed; “small” indicates small cell; “macro” indicates macro cell; and Qhyst relates to the reselection hysteresis.

In another example, for medium speed devices, the following scaling factors can be applied:
“sf-Medium-small for Qhyst” to Qhyst
“sf-Medium-macro for Qhyst” to Qhyst

In yet another example, for normal speed devices, the following scaling factors can be applied:
“sf-Normal-small for Qhyst” to Qhyst
“sf-Normal-macro for Qhyst” to Qhyst

Additionally, the independent scaling factors can include consideration for a cell reselection timer, referred to as Treselection. The Treselection implements a time-to-trigger criteria (e.g., time lapse, time transition) for cell reselection. For example, the timer can be activated when the criteria for cell reselection is completed and, when the timer expires, the user equipment device selects the new cell (provided the conditions are still acceptable for cell reselection). The value of the Treselection can be included in the system information.

Similar to the above example scaling factors, a macro cell can be associated with three (or more) different scaling factors that utilize Treselection and a small cell can be associated with three (or more) different scaling factors. For example, for high speed, the scaling factors can be:
“sf-High-small for TreselectionEUTRA/TreselectionUTRA” to TreselectionEUTRA/TreselectionUTRA
“sf-High-macro for TreselectionEUTRA/TreselectionUTRA” to TreselectionEUTRA/TreselectionUTRA

In another example, for medium speed devices, the following scaling factors can be applied:
“sf-Medium-small for TreselectionEUTRA/TreselectionUTRA” to TreselectionEUTRA/TreselectionUTRA
“sf-Medium-macro for TreselectionEUTRA/TreselectionUTRA” to TreselectionEUTRA/TreselectionUTR

In yet another example, for normal speed devices, the following scaling factors can be applied:
“sf-Normal-small for TreselectionEUTRA/TreselectionUTRA” to TreselectionEUTRA/TreselectionUTRA
“sf-Normal-macro for TreselectionEUTRA/TreselectionUTRA” to TreselectionEUTRA/TreselectionUTR

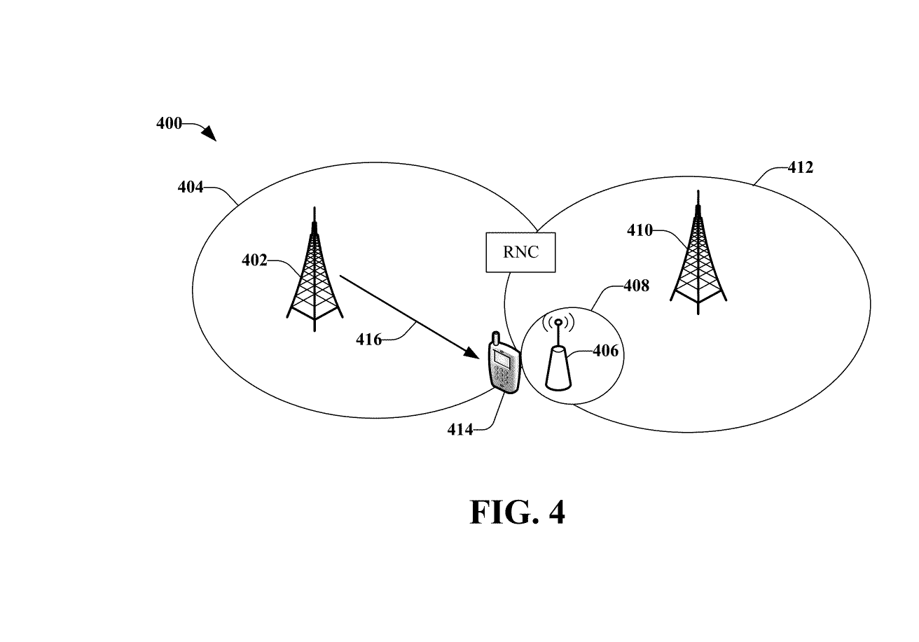

The reselection manager component 210 is configured to apply the proper scaling factor in order to determine which network should be selected/reselected. For example, FIG. 4 illustrates an example, non-limiting wireless network environment 400 that can be utilized with the disclosed aspects. Illustrated is a first cell 402, which can be a current serving cell, and its associated coverage area 404. Also illustrated are a second cell 406 and its associated geographic coverage area 408. For purposes of this example, the second cell 406 is a target network that includes a set of devices that are metro cell enabled devices (e.g., a metro cell network). Also illustrated are a third cell 410 and its associated geographic coverage area 412. For this example, the third cell 410 is a target network that includes a set of devices that are macro cell enabled devices (e.g., a macro cell network). Also illustrated is a user equipment device 414.

The user equipment device 414 detects its mobility state, as discussed herein, which is 35 miles per hour (in this example), which can be considered as a medium speed, according to some implementations. Thus, the user equipment device detected its speed as medium and has received the cell-type information for the first cell 402, the second cell 406, and the third cell 410. The user equipment device is also provided the cell-type specific speed dependent scaling factor for Qhyst and TreselectionEUTRA/TreselectionUTRA, for example, xxx, yyy, respectively. The user equipment device selects the camping cell based on the cell-type and cell-type specific scaling factor.

Since, in this example, the user equipment device is moving at medium speed, small cells will not be the good candidates for the target camping cell. This is because the user equipment device will move out of the cell soon after it moves into the cell, due to the small coverage of the cell.

As indicated in the following Table 1, the first cell and third cell are cell-type “macro” and the second cell is cell-type small. The speed dependent scaling factor (SDSF) for qhysteresis (QHYST) is −4 dB for the macro cells and −2 dB for the small cell. Therefore, assuming normal Qhyst is 5 dB, for the first cell and third cell the calculated Qhyst is 1 dB (e.g., 5 dB−4 dB=1 dB). The calculated Qhyst for the second cell is 3 dB (e.g., 5 dB−2 dB=3 dB). Further, the speed dependent scaling factor for TreselectionEUTRA is 0.5 for the first cell and third cell and 0.75 for the second cell.

TABLE 1

| | | SDSF | | SDSF for | Treselec- | |
|---|---|---|---|---|---|---|
| | Cell- | for | | Treselec- | tion_{EUTRA} | |
| | Type | QHYST | Q_{hyst} | tion_{EUTRA} | _{(assume normal=2 sec)} | |
| First Cell | Macro | −4 dB | 1 dB | 0.5 | 1 | sec |
| Second Cell | Small | −2 dB | 3 dB | 0.75 | 1.5 | sec |
| Third Cell | Macro | −4 dB | 1 dB | 0.5 | 1 | sec |

By applying the small cell (medium speed) specific scaling factor, sf-Medium-Small, as indicated in the above table, the user equipment device triggers the cell reselection to the second cell slower than using the macro cell specific scaling factor, sf-Medium-Macro, for cell reselection to the third cell (e.g., 1.5 second versus 1 second). The decision here can be to reselect the third cell as the camping cell.

In another example, the user equipment device is 414 moving at 1 mile per hour and has detected that its speed is low. Since the user equipment device is moving at low speed, small cells will be the good candidates for the target camping cell. This is because the device should stay in the small cell for a longer amount of time (as compared to a device that is moving at a faster speed) with high probability for small offloading macro traffic.

As indicated in the following Table 2, the first cell and third cell are cell-type “macro” and the second cell is cell-type small. In this case, the speed dependent scaling factor (SDSF) for qhysteresis (QHYST) is −0 dB for the macro cells and −2 dB for the small cell. Therefore, assuming normal Qhyst is 5 dB, for the first cell and third cell the calculated Qhyst is 5 dB (e.g., 5 dB−0 dB=5 dB). The calculated Qhyst for the second cell is 3 dB (e.g., 5 dB−2 dB=3 dB). Further, the speed dependent scaling factor for TreselectionEUTRA is 1.0 for the first cell and third cell and 0.75 for the second cell.

TABLE 2

| | | SDSF | | SDSF for | Treselec- | |
|---|---|---|---|---|---|---|
| | Cell- | for | | Treselec- | tion_{EUTRA} | |
| | Type | QHYST | Q_{hyst} | tion_{EUTRA} | _{(assume normal=2 sec)} | |
| First Cell | Macro | −0 dB | 5 dB | 1 | 2 | sec |
| Second Cell | Small | −2 dB | 3 dB | 0.75 | 1.5 | sec |
| Third Cell | Macro | −0 dB | 5 dB | 1 | 2 | sec |

By applying the small cell (normal speed) specific scaling factor, sf-Normal-Small, as indicated in the above Table 2, the user equipment device triggers the cell reselection to the second cell faster than using the normal macro cell reselection to the third cell. The decision in this example can be to reselect the second cell as the camping cell.

It is noted that in the examples herein, the values are only one of many possible example configurations and other values can be utilized with the disclosed aspects.

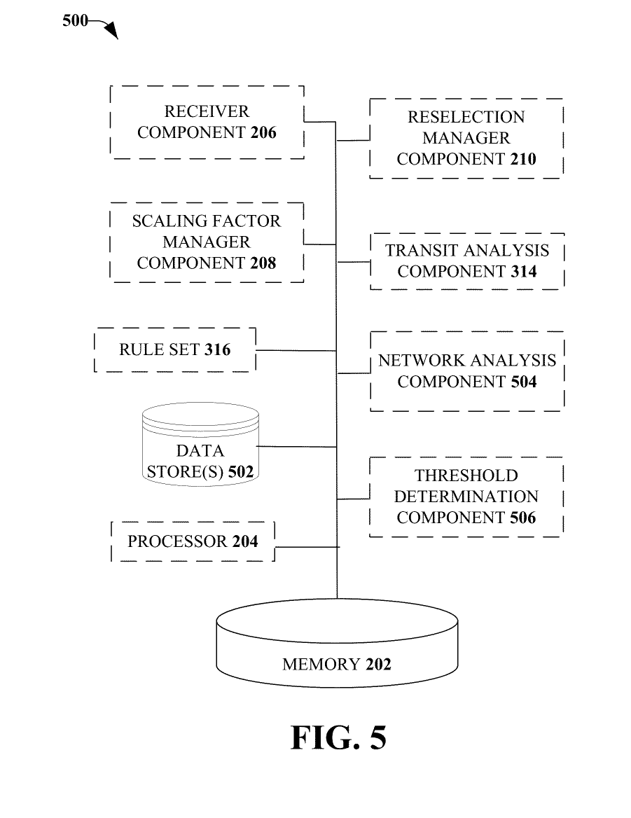

FIG. 5 illustrates an example, non-limiting system 500 for idle mode network traffic load balancing in a heterogeneous communications network, according to an aspect. System 500 includes a memory 202 and a processor 204 operatively connected to the memory 202. A receiver component 206 is configured to receive a first cell-type of a first set of devices of a first network and a second cell-type of a second set of devices of a second network. The receiver component 206 can also receive subsequent cell-types of subsequent sets of devices of respective subsequent networks. Further, the receiver component 206 can receive other information from the cells, including measurements, network traffic load, and so on.

Each of the first network and the second network (as well as other networks) can report their respective cell-types to the system 500, such as in a cell broadcast message. In an example, the neighbor cell information can be reported through a system information block (SIB) message, however, other manners of reporting the information can be utilized. In some aspects, the cell broadcast message can be included in a SIB message, which can contain other information. The SIB message may be a new SIB message configured to include the network traffic load information. Alternatively, the SIB message can be an existing SIB message that has been modified to include the network traffic load information.

The respective cell-types (as well as other information) can be retained in one or more data stores 502. According to an implementation, the one or more data stores 502 can be integrated with the scaling factor manager component 208 and/or memory 202 (or another system component). In another implementation, the one or more data stores 502 can be located external to, but accessible by, the scaling factor manager component 208 and/or memory 202 (or another system component). It is noted that a data store can include volatile memory or nonvolatile memory, or can include both volatile memory and nonvolatile memory. By way of illustration, and not limitation, nonvolatile memory can include read only memory, programmable read only memory, electrically programmable read only memory, electrically erasable programmable read only memory, or flash memory. Volatile memory can include random access memory, which can operate as external cache memory. By way of illustration and not limitation, random access memory is available in many forms such as static random access memory, dynamic random access memory, synchronous dynamic random access memory, double data rate synchronous dynamic random access memory, enhanced synchronous dynamic random access memory, Synchlink dynamic random access memory, and direct Rambus random access memory. The memory (e.g., data stores, databases, and so on) of the various disclosed aspects is intended to comprise, without being limited to, these and any other suitable types of memory.

Also included in system 500 is a transit analysis component 314 that can be configured to determine a mobility state of the user equipment device. The mobility state is a function of a movement pattern of the device and a speed at which the device is determined to be moving. Various techniques can be utilized by the user equipment device to determine its mobility state. According to an aspect, techniques for performing speed detection and radio selection using accelerometers are described in U.S. Pat. No. 8,385,917, entitled “Radio Selection Employing Transit Data Determined from Kinetic Energy Generation”, which is incorporated by reference in its entirety.

Based on the cell-type and the mobility state of the user equipment device, a scaling factor manager component 208 is configured to apply a first scaling factor to the first network and a second scaling factor to the second network when the first network and second network are different cell-types.

In accordance with the decision by the scaling factor manager component 208, the reselection manager component 210 is configured to determine a set of devices (e.g., the first set of devices or the second set of device) for accessing control channels during an idle mode of the device (e.g., for reselection).

In accordance with some implementations, the receiver component 206 is configured to receive a first parameter associated with the first set of devices and a second parameter associated with a second set of devices, as well as respective subsequent parameters associated with the subsequent sets of devices. These various parameters can be evaluated by a network analysis component 504.

The various parameters can include information related to a radio frequency (RF) power of the respective cell. For example, the power of each cell can be measured as absolute power and can be expressed as the power ratio in decibels (dB) of the measured power referenced to one milliwatt (mW), such as, for example, e.g., 2×1 watt vs. 2×5 watt small cells. The notation for this power ratio is dBm.

According to another example, the parameters can include respective load conditions of the networks, respective coverage areas of the networks, and signal strengths associated with the networks. In an example, an average handover signal level can be provided, which can signify the coverage of the cell. According to another example, a signal strength threshold is a reference signal received power (RSRP) over the reference signal subcarriers, in a long term evolution (LTE) implementation. In another example, a signal strength threshold can be a reference (received) signal code power (RSCP) in a universal mobile telecommunications system (UMTS) implementation.

According to some implementations, the receiver component 206 can be configured to receive load condition(s) of each of the cells. In an example, the network traffic or load information received from the various networks can include historic network load information, which is load information obtained based upon network load experienced by the respective network in the past or otherwise in non-real-time. According to some aspects, the historic network load information is used by the network analysis component 504 to identify one or more network load trends over a specified period of time. This trending network load information can be used to predict times during which the network load is favorable as well as the times during which the network load will not be favorable for supporting communications between the user equipment device and the respective network.

In another example, the network traffic information includes current network load information, which is data that is obtained based upon a network load experienced by the network. Real-time, in this context, is the actual time during which a network load is experienced by the network. Near real-time, in this context, is the actual time during which a network load is experienced by the base station, plus a delay on the order of seconds, minutes, or any other order of magnitude thereof, for example. What constitutes near-real time network load information as compared to historic network load information can be defined by a service provider providing service to the network.

The network load information can include a number of active devices (e.g., devices currently engaged in a call or data session). In other embodiments, the load information includes a number of idle devices (e.g., devices currently camped on a given cell). The load information can include active load information and idle load information, which can be utilized separately or together to select a target network.

The network analysis component 504 can be an application program that includes computer-executable instruction that, when executed by the one or more processors 204 causes the system 500 to analyze the received information, and the implementation of the scaling factors by the scaling factor manager component 208 and to instruct the user equipment device to reselect the selected network.

According to some aspects, the network analysis component 504 can utilize additional information to select the particular network. This information can include, but is not limited to, one or more policies and/or one or more user profiles. A policy can be one or more settings, one or more configurations, one or more rules, and so forth, that define, at least in part, one or more courses of action in view of one or more conditions to be used by the network analysis component 504 to decide which target network the user equipment device should be connected to. In some aspects, a policy includes one or more rules that specific one or more if-then conditions for handling a particular situation, such as redirecting network traffic based upon a speed at which the user equipment device is being moved. In accordance with some aspects, a policy can include one or more matrices of cause and effect conditions, tables of actions, and so on for responding to or dealing with various stimuli, include network conditions, mobile device mobility state, and so on.

According to an implementation, prior to the scaling factor manager component 208 applying the scaling factors, a threshold determination component 506 ascertains whether the reported signal strengths meet or exceed a threshold level. For example, a signal strength of a source network is compared to one or more neighbor networks (or target networks). If the reported signal strength of a target network is not at least as good as the source network, or does not exceed the reported signal strength of the source network, that particular target network is removed from consideration and the mobile device does not consider that network in a selection/reselection procedure. However, if the reported signal strength of a network meets the entry level criteria, further analysis of that network is considered in combination with the mobility state of the mobile device.

In an example, if a target network is a metro cell and the mobile device is moving too fast, that metro cell will not be a good target network for the device traffic to move to even though that small cell might have a good radio frequency (RF) condition and might be lightly loaded (e.g., has a low congestion level). This is because if the mobile device is moving too fast and the network traffic of the device is moved to that small cell, it is likely that the mobile device will move out of the coverage area of that small cell soon after that network is selected. This can have a negative performance impact due to the multiple, unnecessary selection/reselection procedures.

According to some implementations, the various aspects disclosed herein can utilize an artificial intelligence component (not shown), which can facilitate automating one or more features in accordance with the disclosed aspects. As discussed herein, the disclosed aspects can be utilized to by a mobile device to execute a selection/reselection procedure such that the device can make a better decision on cell selection/reselection. The disclosed aspects in connection with network selection/reselection and load balancing can employ various artificial intelligence-based schemes for carrying out various aspects thereof. For example, a process for receiving network cell-type and other parameters and a mobility state of a mobile device, applying a scaling factor to the hysteresis based, at least in part, on the cell-type and mobility state.

An example classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that can be automatically performed. In the case of communication systems, for example, attributes can be types of radio networks, congestion thresholds and the classes can be a type of traffic usage (e.g., voice traffic, data traffic, short message service traffic, and so on), the amount of network traffic usage, the expected location of a user equipment device based on a movement parameter, the speed at which the mobile device is being moved, and so on.

A support vector machine is an example of a classifier that can be employed. The support vector machine can operate by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, for example, naïve Bayes, Bayesian networks, decision trees, neural networks, fuzzy logic models, and probabilistic classification models providing different patterns of independence can be employed. Classification as used herein also may be inclusive of statistical regression that is utilized to develop models of priority.

The disclosed aspects can employ classifiers that are explicitly trained (e.g., via a generic training data) as well as implicitly trained (e.g., via observing usage of the user equipment device, by observing a movement pattern of the user equipment device, and so on). For example, support vector machines can be configured via a learning or training phase within a classifier constructor and feature selection module. Thus, the classifier(s) can be used to automatically learn and perform a number of functions, including but not limited to performing a cell selection/reselection procedure as discussed herein.

In view of the example systems shown and described herein, methods that may be implemented in accordance with the one or more of the disclosed aspects, will be better understood with reference to the following flow charts. While, for purposes of simplicity of explanation, the methods are shown and described as a series of blocks, it is to be understood that the disclosed aspects are not limited by the number or order of blocks, as some blocks may occur in different orders and/or at substantially the same time with other blocks from what is depicted and described herein. Moreover, not all illustrated blocks may be required to implement the methods described hereinafter. It is noted that the functionality associated with the blocks may be implemented by software, hardware, in local, cloud, and/or virtualized environment, a combination thereof or any other suitable means (e.g. device, system, process, component). Additionally, it is also noted that the methods disclosed hereinafter and throughout this specification are capable of being stored on an article of manufacture to facilitate transporting and transferring such methodologies to various devices. Those skilled in the art will understand that a method could alternatively be represented as a series of interrelated states or events, such as in a state diagram. The various methods disclosed herein can be performed by a system comprising at least one processor and/or one or more network devices comprising at least one processor.

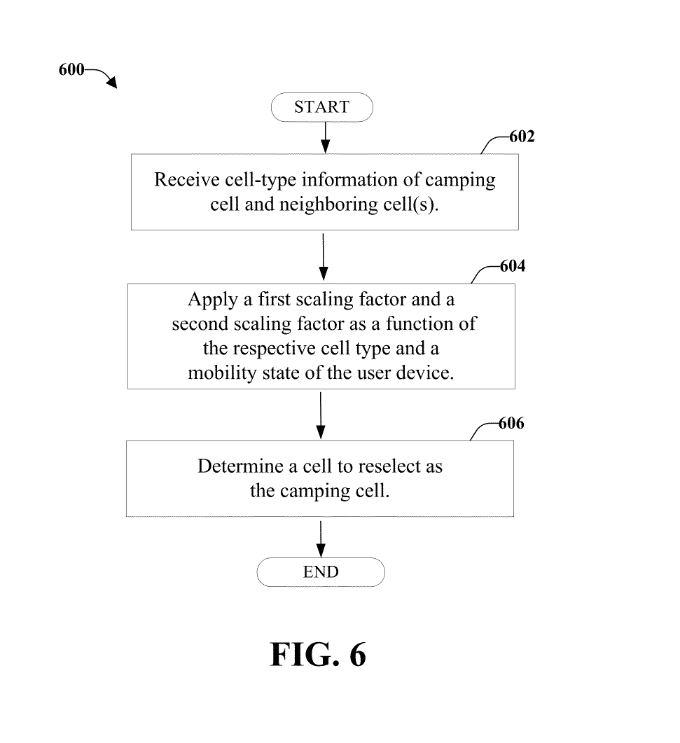

FIG. 6 illustrates an example, non-limiting method 600 for speed dependent heterogeneous network load balancing in idle mode using cell-type specific scaling factor selection, according to an aspect. As disclosed herein, the user equipment device can be provided appropriate cell selection/re-selection parameters, which can be based on the camping and neighbor cells. This allows the user equipment device to make a better decision (as compared to not having this information) on cell selection/reselection. Therefore, the disclosed aspects can improve the end user experience by attempting to only allow the user equipment device to select a proper cell-type in order to reduce a call drop rate in the future (e.g., when the user equipment device exits the idle mode). Such selection can be facilitated by favoring a certain type of cell over another type of cell.

At 602, cell-type information of a camping cell and one or more neighboring cells is received. The cell-type information indicates the radio access technology that the cell utilizes to communicate. For example, the cell-type information can include information related to whether the particular cell is a macro cell, a metro cell, a small cell, a femto cell, a pico cell, and so forth.

A speed dependent scaling factor is applied during a cell selection/reselection procedure, at 604. For example, a first scaling factor can be applied for the camping cell and a second scaling factor can be applied for at least one of the neighboring cells. The particular scaling factor applied is also based on the cell-type and on a mobility state of the mobile device.

At 606, based in part on the results of applying the scaling factor, a determination is made as to the cell to reselect as the camping cell. For example, the first set of devices are enabled to communicate according to a micro cell radio access technology, and the second set of devices are enabled to communicate according to a macro cell radio access technology. Further, the speed of the device is determined to be above a defined level. In this case, the first scaling factor is set to reduce a likelihood of a first selection of the first set of devices, and the second scaling factor is set to increase the likelihood of a second selection of the second set of devices.

According to another example, the first set of devices are enabled to communicate according to a micro cell radio access technology. Further, the speed of the device is determined to be below a defined level. In this case, the first scaling factor is enabled to increase a probability of a first selection of the first set of devices, and the second scaling factor is enabled to reduce the probability of a second selection of the second set of devices.

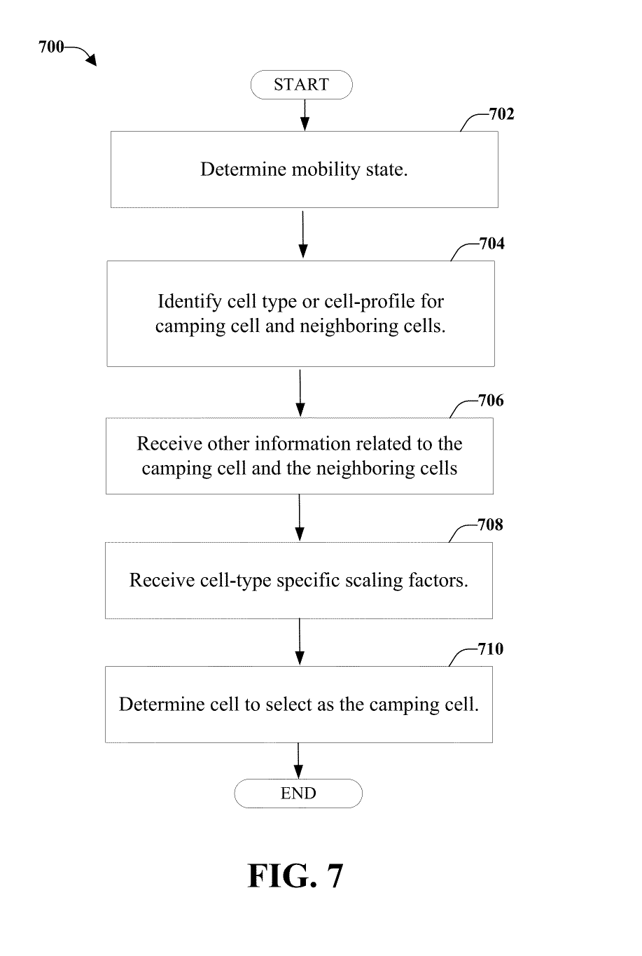

FIG. 7 illustrates an example, non-limiting method 700 for idle mode cell selection/reselection, according to an aspect. At 702, a mobile device determines its mobility state. The mobility state of the mobile device is a function of a movement pattern of the mobile device and a speed at which the mobile device is being moved. A mobility parameter can relate to whether the user equipment device is stationary or is moving and, if moving, a speed at which the user equipment device is being moved. For example, the user equipment device might be stationary (e.g., a user of the user equipment device is sitting at her desk). In another example, the user equipment device might be moved and traveling at any of a variety of different speeds, which can be a function of the mode of transportation (e.g., walking, riding a bicycle, in a car, on a train, in an airplane, and so on). Further, the speed might change over time. For example, the user might be traveling in a car and then get out of the car and walk the remaining distance until arriving at her destination.

Another parameter relates to the direction that the user equipment device is being moved. The direction can be a horizontal direction, which can be associated with cardinal directions or cardinal points (e.g., north, south, east, west, or intermediate points). Further, the direction can include an altitude (or changes in the height) of the user equipment device. For example, the user equipment device might be traveling in an elevator and a range of one network might not reach all points along that altitude (e.g., connectivity is only enabled at the higher locations).

At 704, cell-type (e.g., macro, small, DAS, and so on) or cell-profile for a camping cell and its neighbor cells is identified. For example, the cell information can be received in a system information block message or via other means. Optionally, at 706, other parameters of the camping cell and its neighbor cells are received. For example, the parameter information can include the cell load conditions of the camping cell and neighboring cells. In another example, the parameters can include respective load conditions, respective coverage areas, and respective signal strengths of one or more target networks.

Cell-type specific scaling factors are received, at 708. For example, instead of cell-type independent scaling factors, the network (e.g., serving network) can provide various cell-type specific scaling factors. Such information can be transmitted to the mobile device through a system information message, for example.

At 710, based on the mobility state and the cell-type information, the mobile device can apply the proper scaling factors and make a determination as to a cell to select as a camping cell. Optionally, the parameter information can also be taken into account in the cell selection/reselection process. In an implementation, if a cell does not meet a certain threshold parameter, that cell is removed from consideration for the cell selection/reselection procedure. For example, a signal strength of a cell can be analyzed and, if the signal strength is below a predefined level, the cell is disregarded (e.g., not included in the cell selection/reselection procedure).

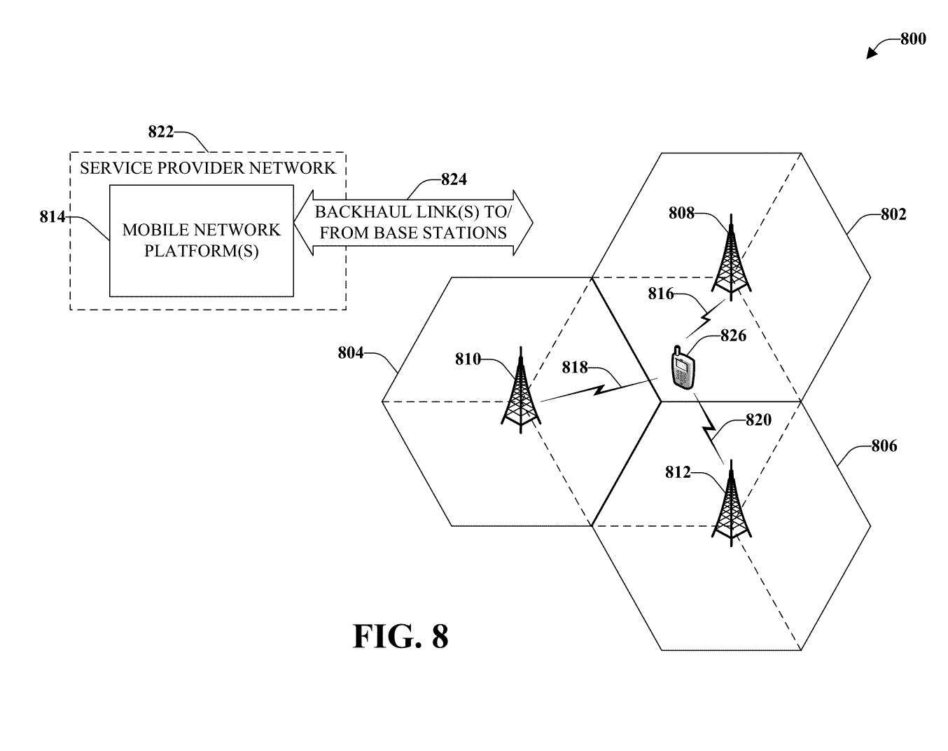

By way of further description with respect to one or more non-limiting ways to facilitate network selection/reselection and load balancing, FIG. 8 is a schematic example wireless environment 800 that can operate in accordance with aspects described herein. In particular, example wireless environment 800 illustrates a set of wireless network macro cells. Three coverage macro cells 802, 804, and 806 include the illustrative wireless environment; however, it is noted that wireless cellular network deployments can encompass any number of macro cells. Coverage macro cells 802, 804, and 806 are illustrated as hexagons; however, coverage cells can adopt other geometries generally dictated by a deployment configuration or floor plan, geographic areas to be covered, and so on. Each macro cell 802, 804, and 806 is sectorized in a 2π/3 configuration in which each macro cell includes three sectors, demarcated with dashed lines in FIG. 8. It is noted that other sectorizations are possible, and aspects or features of the disclosed subject matter can be exploited regardless of type of sectorization. Macro cells 802, 804, and 806 are served respectively through base stations or eNodeBs 808, 810, and 812. Any two eNodeBs can be considered an eNodeB site pair. It is noted that radio component(s) are functionally coupled through links such as cables (e.g., RF and microwave coaxial lines), ports, switches, connectors, and the like, to a set of one or more antennas that transmit and receive wireless signals (not illustrated). It is noted that a radio network controller (not shown), which can be a part of mobile network platform(s) 814, and set of base stations (e.g., eNode B 808, 810, and 812) that serve a set of macro cells; electronic circuitry or components associated with the base stations in the set of base stations; a set of respective wireless links (e.g., links 816, 818, and 820) operated in accordance to a radio technology through the base stations, form a macro radio access network. It is further noted that, based on network features, the radio controller can be distributed among the set of base stations or associated radio equipment. In an aspect, for universal mobile telecommunication system-based networks, wireless links 816, 818, and 820 embody a Uu interface (universal mobile telecommunication system Air Interface).

Mobile network platform(s) 814 facilitates circuit switched-based (e.g., voice and data) and packet-switched (e.g., Internet protocol, frame relay, or asynchronous transfer mode) traffic and signaling generation, as well as delivery and reception for networked telecommunication, in accordance with various radio technologies for disparate markets. Telecommunication is based at least in part on standardized protocols for communication determined by a radio technology utilized for communication. In addition, telecommunication can exploit various frequency bands, or carriers, which include any electromagnetic frequency bands licensed by the service provider network 822 (e.g., personal communication services, advanced wireless services, general wireless communications service, and so forth), and any unlicensed frequency bands currently available for telecommunication (e.g., the 2.4 GHz industrial, medical and scientific band or one or more of the 5 GHz set of bands). In addition, mobile network platform(s) 814 can control and manage base stations 808, 810, and 812 and radio component(s) associated thereof, in disparate macro cells 802, 804, and 806 by way of, for example, a wireless network management component (e.g., radio network controller(s), cellular gateway node(s), etc.). Moreover, wireless network platform(s) can integrate disparate networks (e.g., Wi-Fi network(s), femto cell network(s), broadband network(s), service network(s), enterprise network(s), and so on). In cellular wireless technologies (e.g., third generation partnership project universal mobile telecommunication system, global system for mobile communication, mobile network platform 814 can be embodied in the service provider network 822.

In addition, wireless backhaul link(s) 824 can include wired link components such as T1/E1 phone line; T3/DS3 line, a digital subscriber line either synchronous or asynchronous; an asymmetric digital subscriber line; an optical fiber backbone; a coaxial cable, etc.; and wireless link components such as line-of-sight or non-line-of-sight links which can include terrestrial air-interfaces or deep space links (e.g., satellite communication links for navigation). In an aspect, for universal mobile telecommunication system-based networks, wireless backhaul link(s) 824 embodies IuB interface.

It is noted that while exemplary wireless environment 800 is illustrated for macro cells and macro base stations, aspects of the disclosed subject matter can be implemented in micro cells, pico cells, femto cells, or the like, wherein base stations are embodied in home-based equipment related to access to a network.

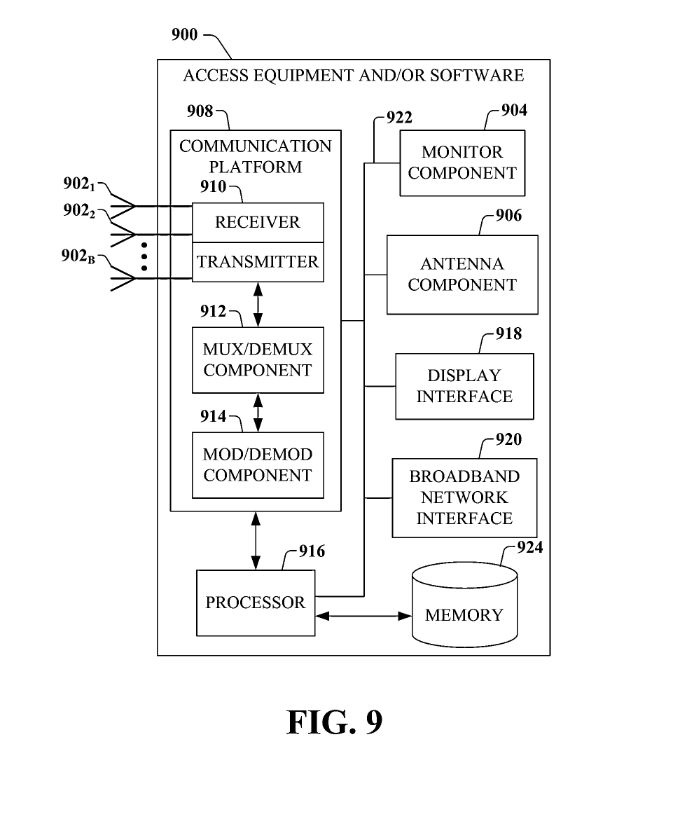

To provide further context for various aspects of the disclosed subject matter, FIG. 9 illustrates a block diagram of an embodiment of access equipment and/or software 900 related to access of a network (e.g., base station, wireless access point, femto cell access point, and so forth) that can enable and/or exploit features or aspects of the disclosed aspects.

Access equipment and/or software 900 related to access of a network can receive and transmit signal(s) from and to wireless devices, wireless ports, wireless routers, etc. through segments 902₁-902_{B} (B is a positive integer). Segments 902₁-902_{B} can be internal and/or external to access equipment and/or software 900 related to access of a network, and can be controlled by a monitor component 904 and an antenna component 906. Monitor component 904 and antenna component 906 can couple to communication platform 908, which can include electronic components and associated circuitry that provide for processing and manipulation of received signal(s) and other signal(s) to be transmitted.

In an aspect, communication platform 908 includes a receiver/transmitter 910 that can convert analog signals to digital signals upon reception of the analog signals, and can convert digital signals to analog signals upon transmission. In addition, receiver/transmitter 910 can divide a single data stream into multiple, parallel data streams, or perform the reciprocal operation. Coupled to receiver/transmitter 910 can be a multiplexer/demultiplexer 912 that can facilitate manipulation of signals in time and frequency space. Multiplexer/demultiplexer 912 can multiplex information (data/traffic and control/signaling) according to various multiplexing schemes such as time division multiplexing, frequency division multiplexing, orthogonal frequency division multiplexing, code division multiplexing, space division multiplexing. In addition, multiplexer/demultiplexer component 912 can scramble and spread information (e.g., codes, according to substantially any code known in the art, such as Hadamard-Walsh codes, Baker codes, Kasami codes, polyphase codes, and so forth).

A modulator/demodulator 914 is also a part of communication platform 908, and can modulate information according to multiple modulation techniques, such as frequency modulation, amplitude modulation (e.g., M-ary quadrature amplitude modulation, with M a positive integer); phase-shift keying; and so forth).

Access equipment and/or software 900 related to access of a network also includes a processor 916 configured to confer, at least in part, functionality to substantially any electronic component in access equipment and/or software 900. In particular, processor 916 can facilitate configuration of access equipment and/or software 900 through, for example, monitor component 904, antenna component 906, and one or more components therein. Additionally, access equipment and/or software 900 can include display interface 918, which can display functions that control functionality of access equipment and/or software 900, or reveal operation conditions thereof. In addition, display interface 918 can include a screen to convey information to an end user. In an aspect, display interface 918 can be a liquid crystal display, a plasma panel, a monolithic thin-film based electrochromic display, and so on. Moreover, display interface 918 can include a component (e.g., speaker) that facilitates communication of aural indicia, which can also be employed in connection with messages that convey operational instructions to an end user. Display interface 918 can also facilitate data entry (e.g., through a linked keypad or through touch gestures), which can cause access equipment and/or software 900 to receive external commands (e.g., restart operation).

Broadband network interface 920 facilitates connection of access equipment and/or software 900 to a service provider network (not shown) that can include one or more cellular technologies (e.g., third generation partnership project universal mobile telecommunication system, global system for mobile communication, and so on) through backhaul link(s) (not shown), which enable incoming and outgoing data flow. Broadband network interface 920 can be internal or external to access equipment and/or software 900, and can utilize display interface 918 for end-user interaction and status information delivery.

Processor 916 can be functionally connected to communication platform 908 and can facilitate operations on data (e.g., symbols, bits, or chips) for multiplexing/demultiplexing, such as effecting direct and inverse fast Fourier transforms, selection of modulation rates, selection of data packet formats, inter-packet times, and so on. Moreover, processor 916 can be functionally connected, through data, system, or an address bus 922, to display interface 918 and broadband network interface 920, to confer, at least in part, functionality to each of such components.

According to some aspects, processor 916 (or more than one processor) can be utilized in supporting a virtualized computing environment. The virtualized computing environment can support one or more virtual machines representing computers, servers, or other computing devices. In such virtualized virtual machines, components such as processors and storage devices may be virtualized or logically represented.

In access equipment and/or software 900, memory 924 can retain location and/or coverage area (e.g., macro sector, identifier(s)) access list(s) that authorize access to wireless coverage through access equipment and/or software 900, sector intelligence that can include ranking of coverage areas in the wireless environment of access equipment and/or software 900, radio link quality and strength associated therewith, or the like. Memory 924 also can store data structures, code instructions and program modules, system or device information, code sequences for scrambling, spreading and pilot transmission, access point configuration, and so on. Processor 916 can be coupled (e.g., through a memory bus), to memory 924 in order to store and retrieve information used to operate and/or confer functionality to the components, platform, and interface that reside within access equipment and/or software 900.

As it employed in the subject specification, the term “processor” can refer to substantially any computing processing unit or device including, but not limited to including, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

In the subject specification, terms such as “store,” “data store,” data storage,” “database,” and substantially any other information storage component relevant to operation and functionality of a component and/or process, refer to “memory components,” or entities embodied in a “memory,” or components including the memory. It is noted that the memory components described herein can be either volatile memory or nonvolatile memory, or can include both volatile and nonvolatile memory.

By way of illustration, and not limitation, nonvolatile memory, for example, can be included in memory 924, non-volatile memory (see below), disk storage (see below), and memory storage (see below). Further, nonvolatile memory can be included in read only memory, programmable read only memory, electrically programmable read only memory, electrically erasable programmable read only memory, or flash memory. Volatile memory can include random access memory, which acts as external cache memory. By way of illustration and not limitation, random access memory is available in many forms such as synchronous random access memory, dynamic random access memory, synchronous dynamic random access memory, double data rate synchronous dynamic random access memory, enhanced synchronous dynamic random access memory, Synchlink dynamic random access memory, and direct Rambus random access memory. Additionally, the disclosed memory components of systems or methods herein are intended to include, without being limited to including, these and any other suitable types of memory.

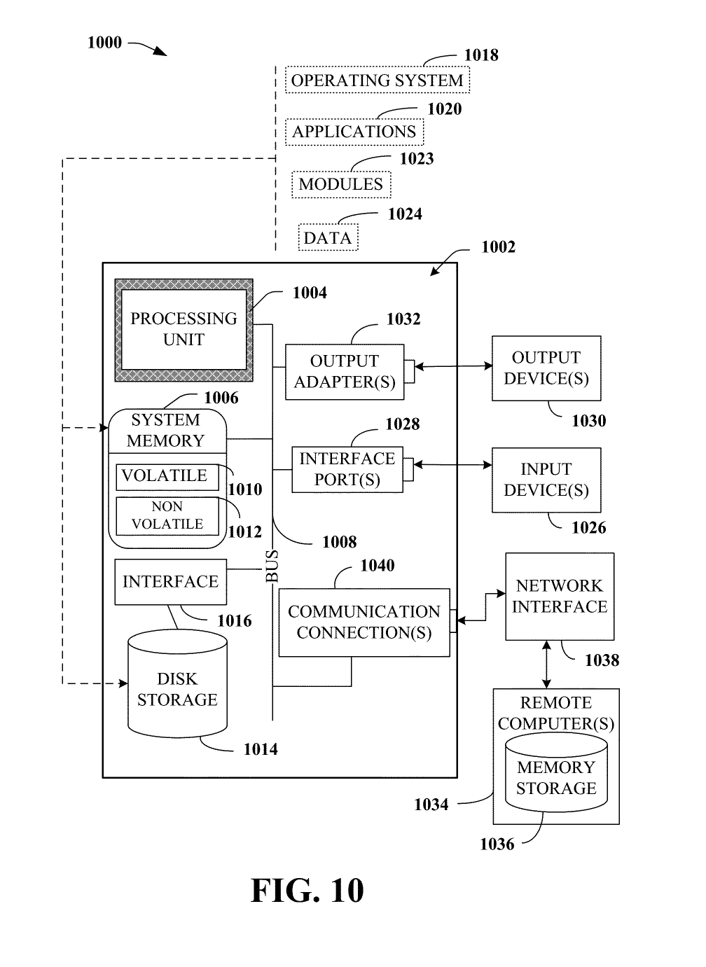

In order to provide a context for the various aspects of the disclosed subject matter, FIG. 10, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the various aspects also can be implemented in combination with other program modules. Generally, program modules include routines, programs, components, data structures, etc. that perform particular tasks and/or implement particular abstract data types. For example, in memory (such as at least one memory 202) there can be software, which can instruct a processor (such as at least one processor 204) to perform various actions. The processor can be configured to execute the instructions in order to implement the analysis of monitoring an uplink power level, detecting the uplink power level is at or above a threshold level, and/or disable transmission of at least one message as a result of the monitored uplink power level.

Moreover, those skilled in the art will understand that the various aspects can be practiced with other computer system configurations, including single-processor or multiprocessor computer systems, mini-computing devices, mainframe computers, as well as personal computers, base stations hand-held computing devices or user equipment, such as a tablet, phone, watch, and so forth, processor-based computers/systems, microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

With reference to FIG. 10, a block diagram of a computing system 1000 operable to execute the disclosed systems and methods is illustrated, in accordance with an embodiment. Computer 1002 includes a processing unit 1004, a system memory 1006, and a system bus 1008. System bus 1008 couples system components including, but not limited to, system memory 1006 to processing unit 1004. Processing unit 1004 can be any of various available processors. Dual microprocessors and other multiprocessor architectures also can be employed as processing unit 1004.

System bus 1008 can be any of several types of bus structure(s) including a memory bus or a memory controller, a peripheral bus or an external bus, and/or a local bus using any variety of available bus architectures including, but not limited to, industrial standard architecture, micro-channel architecture, extended industrial standard architecture, intelligent drive electronics, video electronics standards association local bus, peripheral component interconnect, card bus, universal serial bus, advanced graphics port, personal computer memory card international association bus, Firewire (institute of electrical and electronics engineers 1194), and small computer systems interface.

System memory 1006 includes volatile memory 1010 and nonvolatile memory 1012. A basic input/output system, containing routines to transfer information between elements within computer 1002, such as during start-up, can be stored in nonvolatile memory 1012. By way of illustration, and not limitation, nonvolatile memory 1012 can include read only memory, programmable read only memory, electrically programmable read only memory, electrically erasable programmable read only memory, or flash memory. Volatile memory 1010 can include random access memory, which acts as external cache memory. By way of illustration and not limitation, random access memory is available in many forms such as dynamic random access memory, synchronous random access memory, synchronous dynamic random access memory, double data rate synchronous dynamic random access memory, enhanced synchronous dynamic random access memory, Synchlink dynamic random access memory, and direct Rambus random access memory, direct Rambus dynamic random access memory, and Rambus dynamic random access memory.

Computer 1002 also includes removable/non-removable, volatile/non-volatile computer storage media. In an implementation, provided is a non-transitory or tangible computer-readable storage device storing executable instructions that, in response to execution, cause a system comprising a processor to perform operations. The operations can include receiving a first parameter and a first cell-type of a first set of devices of a first network and a second parameter and a second cell-type of a second set of devices of a second network. The operations can also include applying a first scaling factor to the first parameter and a second scaling factor to the second parameter. The first scaling factor and the second scaling factor are respectively selected based on the first cell-type and the second cell-type, and a mobility state of a device. The mobility state is a function of a movement pattern of the device and a speed at which the device is determined to be moving. Further, the operations can include determining, during a cell reselection procedure, a set of devices to be used for access control channels during an idle mode of the device based on a result of the applying.

According to an implementation, the first set of devices communicate according to a micro cell radio access technology and the second set of devices communicate according to a macro cell radio access technology. Further, based on the speed of the device being determined to be above a defined level, the first scaling factor is configured to reduce a likelihood of a selection of the first set of devices, and the second scaling factor is configured to increase the likelihood of the selection of the second set of devices.

In accordance with another implementation, the first set of devices communicate according to a micro cell radio access technology. Based on the speed of the device being determined to be below a defined level, the first scaling factor is configured to increase a probability of a selection of the first set of devices, and the second scaling factor is configured to reduce the probability of the selection of the second set of devices.

FIG. 10 illustrates, for example, disk storage 1014. Disk storage 1014 includes, but is not limited to, devices such as a magnetic disk drive, floppy disk drive, tape drive, external or internal removable storage drives, superdisk drive, flash memory card, or memory stick. In addition, disk storage 1014 can include storage media separately or in combination with other storage media including, but not limited to, an optical disk drive such as a compact disk read only memory device, compact disk recordable drive, compact disk rewritable drive or a digital versatile disk read only memory drive. To facilitate connection of the disk storage 1014 to system bus 1008, a removable or non-removable interface is typically used, such as interface component 1016.

It is to be noted that FIG. 10 describes software that acts as an intermediary between users and computer resources described in suitable operating environment. Such software includes an operating system 1018. Operating system 1018, which can be stored on disk storage 1014, acts to control and allocate resources of computer system 1002. System applications 1020 can take advantage of the management of resources by operating system 1018 through program modules 1022 and program data 1024 stored either in system memory 1006 or on disk storage 1014. It is to be understood that the disclosed subject matter can be implemented with various operating systems or combinations of operating systems.

A user can enter commands or information, for example through interface component 1016, into computer system 1002 through input device(s) 1026. Input devices 1026 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to processing unit 1004 through system bus 1008 through interface port(s) 1028. Interface port(s) 1028 include, for example, a serial port, a parallel port, a game port, and a universal serial bus. Output device(s) 1030 use some of the same type of ports as input device(s) 1026.

Thus, for example, a universal serial bus port can be used to provide input to computer 1002 and to output information from computer 1002 to an output device 1030. Output adapter 1032 is provided to illustrate that there are some output devices 1030, such as monitors, speakers, and printers, among other output devices 1030, which use special adapters. Output adapters 1032 include, by way of illustration and not limitation, video and sound cards that provide means of connection between output device 1030 and system bus 1008. It is also noted that other devices and/or systems of devices provide both input and output capabilities such as remote computer(s) 1034.

Computer 1002 can operate in a networked environment using logical connections to one or more remote computers, such as remote computer(s) 1034. Remote computer(s) 1034 can be a personal computer, a server, a router, a network computer, a workstation, a microprocessor based appliance, a peer device, or other common network node and the like, and typically includes many or all of the elements described relative to computer 1002.

For purposes of brevity, only one memory storage device 1036 is illustrated with remote computer(s) 1034. Remote computer(s) 1034 is logically connected to computer 1002 through a network interface 1038 and then physically connected through communication connection 1040. Network interface 1038 encompasses wire and/or wireless communication networks such as local area networks and wide area networks. Local area network technologies include fiber distributed data interface, copper distributed data interface, Ethernet, token ring and the like. Wide area network technologies include, but are not limited to, point-to-point links, circuit switching networks, such as integrated services digital networks and variations thereon, packet switching networks, and digital subscriber lines.

Communication connection(s) 1040 refer(s) to hardware/software employed to connect network interface 1038 to system bus 1008. While communication connection 1040 is shown for illustrative clarity inside computer 1002, it can also be external to computer 1002. The hardware/software for connection to network interface 1038 can include, for example, internal and external technologies such as modems, including regular telephone grade modems, cable modems and DSL modems, ISDN adapters, and Ethernet cards.

It is to be noted that the aspects described in the subject specification can be exploited in substantially any communication technology. For example, 4G technologies, Wi-Fi, worldwide interoperability for microwave access, Enhanced gateway general packet radio service, third generation partnership project long term evolution, third generation partnership project 2 ultra mobile broadband, third generation partnership project universal mobile telecommunication system, high speed packet access, high-speed downlink packet access, high-speed uplink packet access, global system for mobile communication edge radio access network, universal mobile telecommunication system terrestrial radio access network, long term evolution advanced. Additionally, substantially all aspects disclosed herein can be exploited in legacy telecommunication technologies; e.g., global system for mobile communication. In addition, mobile as well non-mobile networks (e.g., Internet, data service network such as Internet protocol television) can exploit aspect or features described herein.

Various aspects or features described herein can be implemented as a method, apparatus, or article of manufacture using standard programming and/or engineering techniques. In addition, various aspects disclosed in the subject specification can also be implemented through program modules stored in a memory and executed by a processor, or other combination of hardware and software, or hardware and firmware.

Other combinations of hardware and software or hardware and firmware can enable or implement aspects described herein, including the disclosed method(s). The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical discs (e.g., compact disc, digital versatile disc, blu-ray disc . . . ), smart cards, and flash memory devices (e.g., card, stick, key drive . . . ).

Computing devices typically include a variety of media, which can include computer-readable storage media or communications media, which two terms are used herein differently from one another as follows.

Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, random access memory, read only memory, electrically erasable programmable read only memory, flash memory or other memory technology, compact disk read only memory, digital versatile disk or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

What has been described above includes examples of systems and methods of the one or more aspects. It is, of course, not possible to describe every conceivable combination of components or methods for purposes of describing the aspects, but one of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

As used in this application, the terms “component,” “system,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration, both an application running on a server or network controller, and the server or network controller can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software, or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components. As further yet another example, interface(s) can include input/output components as well as associated processor, application, or application programming interface components.

The term “set”, “subset”, or the like as employed herein excludes the empty set (e.g., the set with no elements therein). Thus, a “set”, “subset”, or the like includes one or more elements or periods, for example. As an illustration, a set of periods includes one or more periods; a set of transmissions includes one or more transmissions; a set of resources includes one or more resources; a set of messages includes one or more messages, and so forth.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

What is claimed is:

1. A method, comprising:
receiving, by a device comprising a processor, a first parameter and a first cell-type of a first set of devices of a first network and a second parameter and a second cell-type of a second set of devices of a second network;
applying, by the device, a first scaling factor to the first parameter and a second scaling factor to the second parameter, wherein the first scaling factor and the second scaling factor are respectively selected based on the first cell-type and the second cell-type, and a mobility state of the device, and wherein the mobility state is a function of a movement pattern of the device and a speed at which the device is determined to be moving; and
determining, by the device, a set of devices used for access to control channels during an idle mode of the device based on a result of the applying.

2. The method of claim 1, wherein the receiving further comprises receiving a first network traffic load condition of the first set of devices and a second network traffic load condition of the second set of devices, and the applying further comprises applying another scaling factor to the first network traffic load condition and the second network traffic load condition.

3. The method of claim 2, wherein the first set of devices and the second set of devices are enabled to communicate according to a macro cell radio access technology and wherein the first parameter comprises a first power level of the first set of devices and the second parameter comprises a second power level of the second set of devices.

4. The method of claim 1, wherein the first set of devices are enabled to communicate according to a micro cell radio access technology, and the second set of devices are enabled to communicate according to a macro cell radio access technology, and, based on the speed of the device being determined to be above a defined level, the first scaling factor is set to reduce a likelihood of a first selection of the first set of devices, and the second scaling factor is set to increase the likelihood of a second selection of the second set of devices.

5. The method of claim 1, wherein the first set of devices are enabled to communicate according to a micro cell radio access technology, and, based on the speed of the device being determined to be below a defined level, the first scaling factor is enabled to increase a probability of a first selection of the first set of devices, and the second scaling factor is enabled to reduce the probability of a second selection of the second set of devices.

6. The method of claim 1, further comprises determining, by the device, a transition time for cell reselection, wherein the first scaling factor and the second scaling factor comprise respective transaction time factors.

7. The method of claim 1, further comprises receiving, by the device, a system information message comprising speed dependent scaling factors, wherein the speed dependent scaling factors comprise the first scaling factor and the second scaling factor.

8. The method of claim 1, wherein the first parameter and the second parameter are reselection hysteresis parameters.

9. The method of claim 1, wherein the determining the set of devices used for access to the control channels is performed during a cell selection procedure or a cell reselection procedure.

10. A system, comprising:
a processor; and
a memory that stores executable instructions that, when executed by the processor, facilitate performance of operations, comprising:
receiving a first parameter and a first cell-type of a first set of devices of a first network and a second parameter and a second cell-type of a second set of devices of a second network;
applying a first scaling factor to the first parameter and a second scaling factor to the second parameter, wherein the first scaling factor and the second scaling factor are respectively selected based on the first cell-type and the second cell-type, and a mobility state of a device, and wherein the mobility state is a function of a movement pattern of the device and a speed at which the device is determined to be moving; and
based on a result of the applying, determining a set of devices for accessing control channels during an idle mode of the device.

11. The system of claim 10, wherein the operations further comprise:
receiving a first network traffic load condition of the first set of devices and a second network traffic load condition of the second set of devices; and
applying another scaling factor to the first network traffic load condition and the second network traffic load condition.

12. The system of claim 11, wherein the first set of devices and the second set of devices are configured to communicate according to a macro cell radio access technology and wherein the first parameter comprises a first power level of the first set of devices and the second parameter comprises a second power level of the second set of devices.

13. The system of claim 10, wherein the operations further comprise receiving a plurality of speed dependent scaling factors in a system information message, wherein the plurality of speed dependent scaling factors comprise the first scaling factor and the second scaling factor.

14. The system of claim 10, wherein the operations further comprise determining a transition time for cell reselection, wherein the first scaling factor and the second scaling factor respectively comprise different transaction time factors.

15. The system of claim 10, wherein the first cell-type of the first set of devices is different from the second cell-type of the second set of devices.

16. The system of claim 10, wherein the determining the set of devices for accessing the control channels is conducted during a cell device selection procedure or a cell device reselection procedure.

17. The system of claim 10, wherein the first parameter and the second parameter are reselection hysteresis parameters

18. A computer-readable storage device storing executable instructions that, in response to execution, cause a system comprising a processor to perform operations, comprising:
receiving a first parameter and a first cell-type of a first set of devices of a first network and a second parameter and a second cell-type of a second set of devices of a second network;
applying a first scaling factor to the first parameter and a second scaling factor to the second parameter, wherein the first scaling factor and the second scaling factor are respectively selected based on the first cell-type and the second cell-type, and a mobility state of a device, and wherein the mobility state is a function of a movement pattern of the device and a speed at which the device is determined to be moving; and
determining, during a cell reselection procedure, a set of devices to be used for access to control channels during an idle mode of the device based on a result of the applying.

19. The computer-readable storage device of claim 18, wherein the first set of devices communicate according to a micro cell radio access technology, and the second set of devices communicate according to a macro cell radio access technology, and, based on the speed of the device being determined to be above a defined level, the first scaling factor is configured to reduce a likelihood of a selection of the first set of devices, and the second scaling factor is configured to increase the likelihood of the selection of the second set of devices.

20. The computer-readable storage device of claim 18, wherein the first set of devices communicate according to a micro cell radio access technology, and, based on the speed of the device being determined to be below a defined level, the first scaling factor is configured to increase a probability of a selection of the first set of devices, and the second scaling factor is configured to reduce the probability of the selection of the second set of devices.
